(19) United States
(12) Patent Application Publication
(10) Pub. No.: US 2003/0067492 A1
(43) Pub. Date: Apr. 10, 2003

(54) Flashwarn (FW)

(76) Inventor: Charles W. Cadwallader, Philadelphia, PA (US)

Correspondence Address: Charles W. Cadwallader, 2036 Spruce Street, Philadelphia, PA, 19103, US

(21) Appl. No.: 10/242,946

(22) Filed: Sep. 16, 2002

Related U.S. Application Data
(60) Provisional application No. 60/323,218, filed on Sep. 17, 2001.
(60) Provisional application No. 60/323,217, filed on Sep. 17, 2001.

(51) Int. Cl. G09G 5/00

(52) U.S. Cl. 345/779

(57) ABSTRACT

Project CNs in Time Scaled Critical Path (TSCPM) and Bar/Gantt Chart (Bar Chart) Precedence Network Diagrams extend vertically through all horizontal rows occupied by the project plan tasks/activities (tasks) and are placed at the horizontal position in time of a project's final task's scheduled completion. Whenever a Project CN has been extended/delayed in time due to plan rescheduling, it will be highlighted to become a Project FW. In project plans that have a Project FW as a result of rescheduling, each task that lies on the critical path of that project plan and which has increased in duration as a result of the same plan rescheduling is highlighted to become a Task FW.

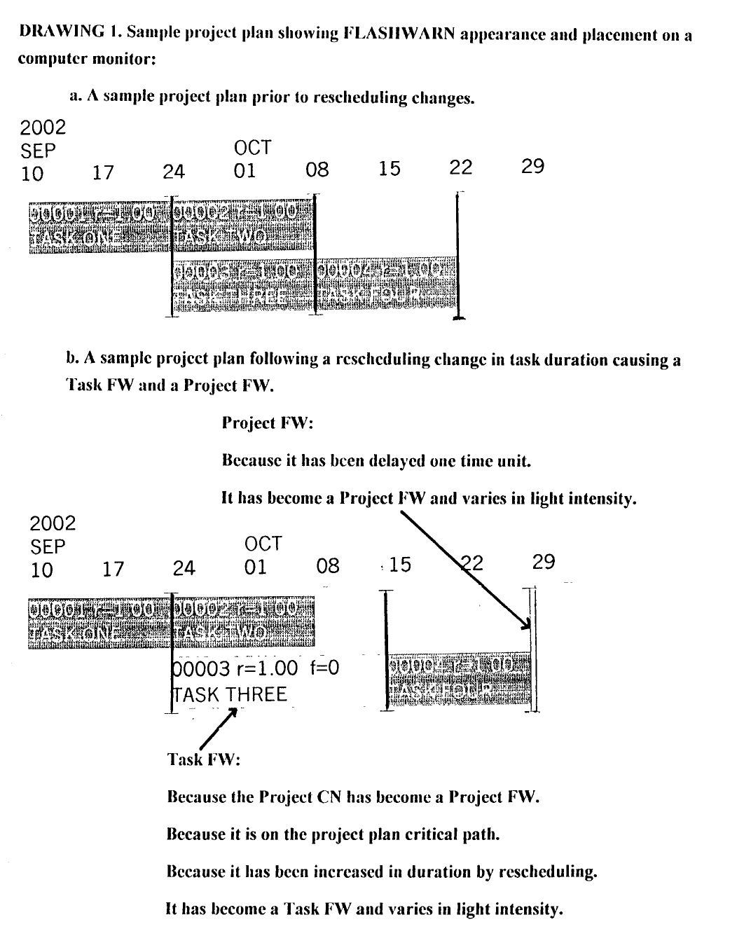

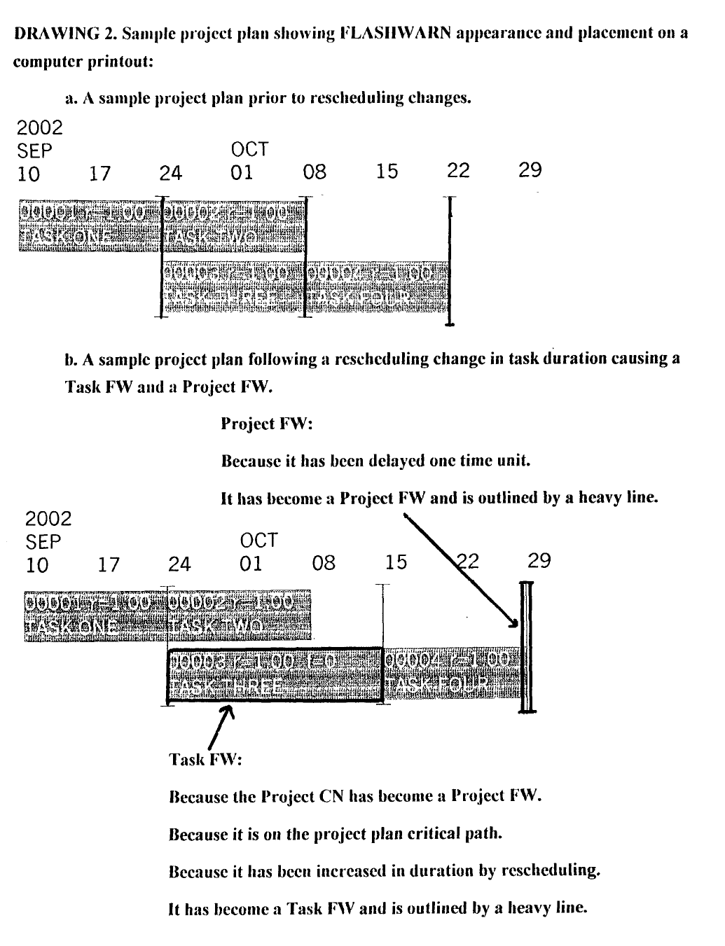

On computer screens FWs consist of highlighting the qualifying Project CN and qualifying tasks by varying their light value. The value of the light intensity and the rate of change of light intensity is at the discretion of the system designer.

On computer printouts FWs consist of outlining qualifying Project CNs and the qualifying task or tasks. The color or thickness of the outline is at the discretion of the system designer.

### BACKGROUND OF THE INVENTION

Over time, man has devised management innovations that also improved project management, such as Work Breakdown Structure, Span of Control, and Management By Objectives. Man has also devised methods of planning and controlling projects, such as Task Lists, Bar Charts, PERT (Program Evaluation and Review Technique), and CPM (Critical Path Method). All of these methods were later programmed as systems for the computer to make the computations and presentations that are a picture of the project. These project management systems determine the critical points in project plans but do not properly present those critical points to the viewer. By highlighting the Project CN representing an extended project duration (Project FW) and the tasks that caused that extention (Task FW), planners and managers can easily see the critical, detrimental problem areas of a project plan and can devote their attention to correction of those problems areas, rather than seeking the cause of those problem areas. FWs also assures that plan problem areas do not escape the attention of planners and managers.

In project management consulting it was noted that many in corporate management, especially top management, could not read project management plan displays. Few wanted to admit to this condition. This put the power of project status in the Project Manager's hands and left top management uninformed. TSCPM and Bar Charts helped by presenting logical project plans, but they lacked the important function of properly displaying (highlighting) critical problem areas.

The idea came to mind that, if critical project tasks and project completion nodes of plans extended in duration by rescheduling were highlighted, problems could be easily detected and corrected. That idea worked on both hand drawn and computer generated project plans. Hand drawn plans, however, require so much redrawing following any small change in planning that they are impractical. A change in the early stages of a plan would require redrawing of the whole plan. With the computer's rapid calculation, rescheduling a plan at any point is not a problem. With that in mind, this claim is dependant upon computer generated TSCPM and computer generated Bar Chart project plan displays presented on computer screens or computer printouts.

### SUMMARY

Project CNs in Time Scaled Critical Path (TSCPM) and Bar/Gantt Chart (Bar Chart) Precedence Network Diagrams extend vertically through all horizontal rows occupied by the project plan tasks/activities (tasks) and are placed at the horizontal position in time of a project's final task's scheduled completion. Whenever a Project CN has been extended/delayed in time due to plan rescheduling, it will be highlighted to become a Project FW. In project plans that have a Project FW as a result of rescheduling, each task that lies on the critical path of that project plan and which has increased in duration as a result of the same plan rescheduling is highlighted to become a Task FW.

The graphic of Project FWs and Task FWs are a change in light intensity to bright or dull and then back to their original intensity on a computer monitor and outlining Project FWs and Task FWs with noticably heavy lines on computer printouts. The function of such Task FWs and Project FWs is to bring project plan extentions in duration and the cause of those project plan extentions to the attention of project planners and management. Such FWs remain until the condition is corrected by rescheduling the project.

The flashing (highlighting) of both Task FWs and Project FWs on computer monitors can vary in time interval of flash, color, contrast, etc. The basis of the claim is that computer monitor FWs noticably flash to attract the attention of planners and managers.

The outlining (highlighting) of both Task FWs and Project FWs on computer printouts can vary in color, width of outline, placement of outline inside or outside task FWs, keystroke configuration, etc. The basis of the claim is that computer printout FWs noticably attract the attention of planners and managers.

Though the programming for Task FWs and Project FWs has been accomplished, this claim is for the placement and appearance of those Task FWs and Project FWs.

### BRIEF DESCRIPTION OF THE DRAWINGS

The drawings are to indicate the change due to highlighting of Task FWs and Project FWs when a task or tasks on the critical path of a TSCPM or Bar Chart project plan have been replanned to increase in duration which in turn has extended the project completion date. Variable light intensity and attention getting color are the very bases of this claim, but It is difficult to show light intensity and color in drawings that are required to be black and white. I have had to use notes on the drawings to indicate these features.

### DRAWINGS

1. DRAWING 1. Sample project plan showing FWs appearance and placement on a computer monitor.

2. DRAWING 2. Sample project plan showing FWs appearance and placememt on a computer printout.

### FIELD OF THE INVENTION

The FW is a display claim. It has a definite task related and project completion related position in TSCPM and Bar Chart type Precedence Network Diagrams. TSCPM and Bar Chart FW displays can be programmed to vary in many different ways, light intensity, frequency of flash, color, etc., but FWs will always involve qualifying, critical tasks and qualifying project completions column nodes. FWs will be by noticable changing of light intensity of qualifying tasks and of qualifying project completion column nodes on computer monitors and noticable outlining of qualifying tasks and of qualifying project completion column nodes on computer printouts.

This claim is for the placement and visual attraction of FWs, to warn planners and managers of extended durations in project plans.

### DESCRIPTION

Time Scaled Critical Path Method (TSCPM) and Bar/Ghantt Chart (Bar Chart) Precedence Network Diagrams have a horizontal frame that contains a calendar time scale of time units selected by the project planner and horizontal, parallel rows beneath that time scale to contain project Tasks/Activities (Tasks). Tasks are placed in those horizontal rows below the Time Scale at the time selected by the project planner and in the rows indicating their relationship to other tasks in the project. In TSCPM, rows and tasks that fit in them, have a vertical depth which allows for the tasks identification to be written on the face of the task. In Bar Charts, rows have a vertical depth which allows for the task identification to be written in a column on the left edge of the rows.

Column Nodes (CNs) are graphic illustrations of the invisible nodes in Time Scaled Critical Path Method (TSCPM) and Bar/Ghantt Charts (Bar Chart) Precedence Network Diagrams. CNs In TSCPMs and Bar Charts are vertical lines with caps on the top and bases on the bottom. Task CNs denote the time in a plan where completion of a scheduled task or tasks, or designated portions thereof, plus their float impact temporally on a scheduled primary dependant task or tasks. Project CNs indicate the scheduled time of completion of the final task or tasks of projet.

Appearance:

On a computer monitor screen all FWs involve the varience in light intensity of an entire qualifying task (Task FW) and the entire column node which signifies the time of project completion (Project FW). The frequency of the flash, the color of the flash, the intensity of the flash, or any other configuration of the flash are the perogative of the system designer.

On a computer printout all FWs involve a outline within or outside of the qualifying task and a outline outside of the qualifying project completion node represented by a column (Project CN). The outline width, color, or any other configuration of the outline is the perogative of the system designer.

Placement:

a. Project FW:

Project CNs, designating the current completion time of the project plan, extend vertically through all horizontal rows occupied by the project plan at the horizontal position in time of a project's final task's or tasks' scheduled completion.

Whenever the project plan has been scheduled to extend in duration during the last, previous rescheduling, the Project CN becomes a Project FW.

b. Task FW:

To affect the duration of a project, a task, or tasks, must be on the critical path of the project plan. The critical path of a project plan is that path of tasks through the plan which has no, or the least, float. The critical path can change with replaning a plan. A Task FW is always on the critical path of the current project plan and is a task that has been extend in duration during the last, previous project plan rescheduling and that extention in task duration has extended the duration of the entire project plan, causing a Project FW.

Some Tasks on the critical path may have dependencies on only a portion of their duration. In such cases that entire task will be a Task FW if its extended duration extends the duration of the entire project plan.

c. Initiation of FWs:

FWs are initiated each time a rescheduled plan that extends the plan duration is “saved” in the computer.

d. Removal of FWs:

FWs are removed each time a rescheduled plan not extending the plan duration is “saved” in the computer.

Though the programming of Task FWs and Project FWs has been accomplished, this claim is for the position and appearance of Task FWs and Project FWs, only.

This patent is of computer generated flashing (highlighted) Task FWs and Project FWs displayed on computer monitors and computer generated outlined (highlighted) Task FWs and Project FWs displayed on computer printouts. These FWs demonstrate, in an obvious manner, that difficult to discern problems exist and where they exist in TSCPM and Bar Chart Precedence Network Diagrams project plans.

Having thus disclosed my invention I claim:

1. FWs in computer generated TSCPM and Bar Chart displays of project plans are the bases for improved detection and understanding of the impact of duration changes in critical path tasks. The improvements comprising:
a. A means for TSCPM and Bar Charts to display extended project duration to planners and management following reschedule of an approved plan.
b. a. A means for TSCPM and Bar Charts to display an extended task duration, which in turn extends project duration, to planners and management following reschedule of an approved plan.
c. A means for quick, and accurate response to those influences that cause extended project duration and extended task duration to planners and management following reschedule of an approved plan.

2. FWs in computer generated TSCPN or Bar Chart displays of project plans are the bases for improved coordination, control, communications, and commitment on projects. The improvements comprising:
a. A common means of cordination: Due to the obvious display of problem, Task FWs. The clarity of the display of a problem assigns corrective action to the Task FW Manager. Task FW managers, responsible for performance and completion of their tasks, can easily accertain how failure in their Task impacts on their fellow project team members and the project itself and how they must resolve those problems in the best interests of the project sponsor.
b. A common means of cordination: Due to the obvious display of problem project CNs (Project FWs). The clarity of the Project FW display assigns corrective action to the project manager. Project managers, responsible for performance and completion of their projects on time, can easily accertain the impact of a Project FWs on other corporate plans and how those problems must be resolved in the best interests of the project sponsor.
c. A common means of control: Due to the obvious computer generated display of Task FWs and Project FWs, the task responsibility, the project manager, and top management can all observe problems over a common reflection of a project and find mutually accepted corrections. This problem solving can be done involving the project manager who can replan to incorporate changes, and if necessary, involving top management, who can assign additional resources, where necessary. All levels of managememt can see a problem best in a computer generated TSCPM or Bar Chart project plan when it contains FWs.
d. A common means of clear communication: Due to the obvious computer generated display of FWs and their impact on a project schedule. All project personnel, from the task responsibility to top management can view and discuss TSCPM and Bar Charts best with FWs, knowing that they all are correcting the same problems.
e. A common means of enhancing commitment to a project: Due to the obvious computer presentation of Task FWs and Project FWs and their impact on other tasks, nodes and other projects. The Task Manager responsible for performing a task becomes well aware that his Task FW has an impact on other tasks and resources. And that fact is is clearly visible to all. This widespread imformation tends to encourage the task manager to maintain his part of the scheduled plan.
